(19) United States
(12) Patent Application Publication
(10) Pub. No.: US 2019/0092689 A1
(43) Pub. Date: Mar. 28, 2019

(54) MIGRATING STARCH WITH HIGH COLD-WATER SOLUBILITY FOR USE IN PREPARING GYPSUM BOARD

(71) Applicant: United States Gypsum Company, Chicago, IL (US)

(72) Inventors: Yijun SANG, Oak Park, IL (US); Mark K. HEMPHILL, Hawthorn Woods, IL (US)

(73) Assignee: United States Gypsum Company, Chicago, IL (US)

(21) Appl. No.: 16/126,969

(22) Filed: Sep. 10, 2018

Related U.S. Application Data
(60) Provisional application No. 62/563,439, filed on Sep. 26, 2017.

(51) Int. Cl. C04B 28/14; C04B 24/38; C04B 22/12; C04B 40/00

(52) U.S. Cl. CPC C04B 28/145; C04B 24/38; C04B 2111/0062; C04B 40/0028; C04B 22/12

(57) ABSTRACT

Disclosed is gypsum board formed from stucco, water, and at least one migrating starch having a cold-water solubility of at least about 25%. Generally, the starch has a viscosity of less than about 20 centipoise (e.g., from about 1 centipoise to about 20 centipoise), as determined according to the VMA method. Also disclosed are related slurries and methods of preparing gypsum board.

### CROSS-REFERENCE TO RELATED APPLICATION

This patent application claims the benefit of priority to U.S. Provisional Patent Application No. 62/563,439, filed Sep. 26, 2017, and entitled “MIGRATING STARCH WITH HIGH COLD-WATER SOLUBILITY FOR USE IN PREPARING GYPSUM BOARD,” which is incorporated by reference in its entirety herein.

### BACKGROUND OF THE INVENTION

Set gypsum is a well-known material that is used in many products, including panels and other products for building construction and remodeling. One such panel (often referred to as gypsum board) is in the form of a set gypsum core sandwiched between two cover sheets (e.g., paper-faced board) and is commonly used in drywall construction of interior walls and ceilings of buildings. One or more dense layers, often referred to as “skim coats” may be included on either side of the core, usually at the paper-core interface.

Gypsum (calcium sulfate dihydrate) is naturally occurring and can be mined in rock form. It can also be in synthetic form (referred to as “syngyp” in the art) as a by-product of industrial processes such as flue gas desulfurization. From either source (natural or synthetic), gypsum can be calcined at high temperature to form stucco (i.e., calcined gypsum in the form of calcium sulfate hemihydrate and/or calcium sulfate anhydrite) and then rehydrated to form set gypsum in a desired shape (e.g., as a board). During manufacture of the board, the stucco, water, and other ingredients as appropriate are mixed, typically in a pin mixer as the term is used in the art. A slurry is formed and discharged from the mixer onto a moving conveyor carrying a cover sheet with one of the skim coats (if present) already applied (often upstream of the mixer). The slurry is spread over the paper (with skim coat optionally included on the paper). Another cover sheet, with or without skim coat, is applied onto the slurry to form the sandwich structure of desired thickness with the aid of, e.g., a forming plate or the like. The mixture is cast and allowed to harden to form set (i.e., rehydrated) gypsum by reaction of the calcined gypsum with water to form a matrix of crystalline hydrated gypsum (i.e., calcium sulfate dihydrate). It is the desired hydration of the calcined gypsum that enables the formation of the interlocking matrix of set gypsum crystals, thereby imparting strength to the gypsum structure in the product. Heat is required (e.g., in a kiln) to drive off the remaining free (i.e., unreacted) water to yield a dry product.

Different types of starches can be used in the preparation of gypsum board. Starches generally contain two types of polysaccharides (amylose and amylopectin) and are classified as carbohydrates. One use of starch in the preparation of gypsum board is to enhance strength in the gypsum core. Such starches are generally non-migratory because the size of the molecules restricts the movement of the starch in a gypsum layer during the manufacturing process. Often, the strength-enhancing starches are pregelatinized, typically through thermal means. Generally, pregelatinized starches can form dispersions, pastes, or gels with cold water. The pregelatinized starches can be chemically modified (e.g., acid-modified) to tailor the desired properties of the starch, including reducing water demand. See, e.g., commonly assigned U.S. Pat. No. 9,540,810, and U.S. patent application Ser. Nos. 13/835,002 and 14/494,547. Other types of strength enhancing starches include alkylated (e.g., ethylated) starches that may not be pregelatinized.

In addition to the use of strength-enhancing non-migrating starches, migratory starches, with smaller molecular size, have been used in attempts to enhance paper-core bonding. These migrating starches are typically acid-modified such that they generally have smaller molecular size than the non-migrating strength-enhancing starches. Existing migrating starches have not been fully satisfactory. Often, the starch does not migrate to the paper-core interface sufficiently. This can result in surface calcination, which is an undesirable condition that can lead to waste and inefficiencies in manufacture. Thus, there is a need in the art for an improved migrating starch.

It will be appreciated that this background description has been created by the inventors to aid the reader, and is not to be taken as a reference to prior art nor as an indication that any of the indicated problems were themselves appreciated in the art. While the described principles can, in some regards and embodiments, alleviate the problems inherent in other systems, it will be appreciated that the scope of the protected innovation is defined by the attached claims, and not by the ability of the claimed invention to solve any specific problem noted herein.

### BRIEF SUMMARY OF THE INVENTION

The present disclosure relates to gypsum board, slurries, and methods of production of gypsum board. A migrating starch (e.g., acid-modified) with high cold-water solubility (i.e., at least about 25%) is used. The migrating starch desirably has a viscosity of less than about 20 centipoise, as determined according to the VMA method. The VMA method is described in, e.g., U.S. Pat. No. 9,540,810. Desirably, the migrating starch with these characteristics are able to effectively migrate to the interface between the cover sheet (e.g., paper) and a gypsum layer. Gypsum board prepared using migrating starch with high cold-water solubility and viscosity of less than 20 centipoise, in accordance with the present disclosure, exhibits reduced incidence of surface calcination and/or improved cover sheet-gypsum layer bond.

Thus, in one aspect, the present disclosure provides a gypsum board. The gypsum board comprises a set gypsum core disposed between two cover sheets. The core is formed from a slurry. The slurry comprises stucco, water, and at least one migrating starch. The migrating starch has a cold-water solubility of at least about 25% and a viscosity of less than about 20 centipoise, as determined according to the VMA method.

In another aspect, the present disclosure provides a slurry comprising stucco, water, and at least one migrating starch. The migrating starch has a cold-water solubility of at least about 25% and a viscosity of less than about 20 centipoise, as determined according to the VMA method.

In another aspect, the present disclosure provides a method of making gypsum board. The method comprises mixing at least water, stucco, and at least one migrating starch to form a slurry. The slurry is disposed between a first cover sheet and a second cover sheet to form a wet assembly. The wet assembly is cut into a board. The board is dried. The migrating starch has a cold-water solubility of at least about 25% and a viscosity of less than about 20 centipoise, as determined according to the VMA method.

In another aspect, the present disclosure provides a method of reducing the incidence of surface calcination in a method of making gypsum board. The method comprises introducing at least one migrating starch into a stucco slurry. The migrating starch, e.g., which can be acid-modified, has a cold-water solubility of at least about 25% and a viscosity of less than about 20 centipoise, as determined according to the VMA method. The slurry is disposed between a first cover sheet and a second cover sheet to form a wet assembly. The wet assembly is cut into a board. The board is dried. The dried board exhibits reduced incidence of surface calcination compared with a board prepared from a method that does not include in the slurry the migrating starch having a cold-water solubility of at least about 25% and a viscosity of less than about 20 centipoise.

In another aspect, the present disclosure provides a method of improving cover sheet-gypsum layer bond in a gypsum board. In some embodiments, the cover sheet is formed from paper. The method comprises introducing at least one migrating starch into a stucco slurry. The migrating starch, e.g., which can be acid-modified, has a cold-water solubility of at least about 25% and a viscosity of less than about 20 centipoise, as determined according to the VMA method. The slurry is disposed between a first cover sheet and a second cover sheet to form a wet assembly. The wet assembly is cut into a board. The board is dried. The dried board exhibits improved cover sheet-gypsum layer bond compared with a board formed from a slurry that does not include the migrating starch having a cold-water solubility of at least about 25% and a viscosity of less than about 20 centipoise.

### DETAILED DESCRIPTION OF THE INVENTION

The present disclosure is predicated, at least in part, on the surprising and unexpected discovery that a migrating starch having high cold-water solubility (i.e., at least about 25%) and low viscosity (i.e., about 20 centipoise or less as measured according to the VMA method) can be used in manufacturing gypsum board, e.g., wallboard. It will be understood that the term “wallboard” is not limited to use on wall surfaces, but also can refer to gypsum board used on ceilings, partitions, etc. The migrating starch is typically acid-modified.

The present inventors have discovered that the high level of cold-water solubility and low viscosity surprisingly and unexpectedly migrate more effectively to the interface between (a) the gypsum slurry layer in which it is introduced and (b) the cover sheet (e.g., paper), during the board manufacturing process. While not wishing to be bound by any particular theory, it is believed that more insoluble migrating starch (e.g., having solubility of less than 21%) do not migrate as effectively since insoluble portions of the starch migrate after gelatinization in situ during manufacture where such gelatinization renders the starch water soluble and more mobile. In contrast, the migrating starch with higher cold-water solubility and low viscosity allows for mobility of the starch even prior to any gelatinization such that the starch has more time and ability to migrate to the cover sheet-gypsum layer interface during the manufacturing process. For example, a migrating starch such as LC-211 supplied by Archer Daniels Midland, Chicago, Ill., is less desirable than cold-water soluble migrating starches with lower viscosity according to the present disclosure. LC-211 has lower solubility (approximately 20%) and has a higher viscosity (and higher molecular height) than cold-water soluble, low viscosity migrating starches according to the present disclosure.

The use of the migrating starch with high cold-water solubility and low viscosity in accordance with the present disclosure results in reduced incidence of surface calcination and end burn, as well as allowing for improved bond between the cover sheet and the gypsum layer formed from slurry containing the migrating starch. Surface calcination can occur where the surface of the gypsum layer is dried more rapidly than the core such that the surface reaches the calcination temperature (e.g., generally from about 120° C. to about 180° C.) while the core remains at a lower temperature due to a higher free water content. Surface calcination is undesirable because it can destroy gypsum crystal structure, resulting in a softer, chalky material with less strength. Surface calcination is also undesirable because it compromises the ability of gypsum crystals to penetrate into the cover sheet matrix, which is believed to be how good cover sheet-gypsum layer bond can be attained. Migrating starches with high cold-water solubility and low viscosity according to the present disclosure address these drawbacks by allowing for enhanced migration of the starch, resulting in reduced incidence of surface calcination and improved bond between the gypsum layer and the cover sheet.

Any suitable type of raw starch material can be used in forming the migrating starch with high cold-water solubility and low viscosity as described herein. As used herein, the starch material can be a material (such as flour) that includes a starch component of any suitable proportion (e.g., a starch component of 75% or higher in the material). For example, in some embodiments, the starch material can be in the form of corn starch, pea starch, wheat starch, alkylated starch, oxidized starch, flour-containing starch such as corn flour, etc.

The migrating starch according to the present disclosure is typically acid-modified or enzyme modified for hydrolysis to reduce molecular weight. While not wishing to be bound by any particular theory, it is believed that the acid or enzyme modification cleaves maltodextrins off the starch macromolecules. To prepare acid-modified starches, it will be appreciated that either an aqueous acidic suspension of unmodified starch or a dry mixture (<20% moisture) of unmodified starch and an acid can be treated at an elevated temperature. By adjusting reaction time, acid level and reaction temperature, the degree of depolymerization can be modified. For example, when the proper fluidity is achieved, e.g., as determined by in-process laboratory controls, the acid hydrolysis reaction can be stopped by neutralizing the acid or reducing the temperature to room temperature. Thus, acid-modified starches can be prepared in various fluidities. Also, acid-modified starches may be used directly or after neutralization without further purification. The most commonly used starch-converting enzyme is α-amylase (alpha-amylase). The enzyme hydrolysis reaction can be stopped either by adjusting the pH or by heating.

The migrating starch has a high cold-water solubility, i.e., greater than about 25%. In various embodiments, any upper limit of cold-water solubility can be effective (up to 100%) so long as the migrating starch also has the low viscosity described herein. For example, in some embodiments, the migrating starch has a cold-water solubility of at least about 30%, at least about 35%, at least about 40%, at least about 45%, at least about 50%, etc. In some embodiments, the migrating starch has a cold-water solubility of, for example, from 25% to about 90%, from about 25% to about 80%, from about 25% to about 70%, from about 25% to about 60%, from about 25% to about 50%, from about 25% to about 40%, from about 27% to about 90%, from about 27% to about 80%, from about 27% to about 70%, from about 27% to about 60%, from about 27% to about 50%, from about 27% to about 40%, from about 30% to about 90%, from about 30% to about 80%, from about 30% to about 70%, from about 30% to about 60%, from about 30% to about 50%, from about 30% to about 70%, from about 35% to about 90%, from about 35% to about 80%, from about 35% to about 70%, from about 35% to about 60%, from about 35% to about 50%, from about 40% to about 90%, from about 40% to about 80%, from about 40% to about 70%, from about 40% to about 60%, from about 40% to about 50%, etc.

The cold-water solubility of the starch is measured by the following method. A wet starch is formed by adding water (80 mL, room temperature (25° C.)) and dry starch (4.000 g) to a beaker with stirring. The wet starch is stirred for 20 minutes, and then transferred into a 100 ml graduated cylinder. Water is added up to the 100 mL line, and then the cylinder is inverted three times to mix the slurry. The wet starch is allowed to stand for 30 minutes at room temperature. The supernatant (10 g) is transferred from the top of the slurry into a tared pan. After the pan is heated overnight (43° C.), the remaining solids are weighed. The solubility (%) of the starch is set forth in the equation: Solubility (%)=Weight of soluble solid/(0.4×100).

The migrating starch has a low viscosity of about 20 centipoise or less according to the VMA method. The viscosity is indicative of starch molecule size and molecular weight such that lower viscosity of the migrating starch generally indicates lower molecular weight and molecule size. For example, in some embodiments, the migrating starch has a viscosity of from about 1 centipoise to 19.5 centipoise, from about 1 centipoise to 19 centipoise, from about 1 centipoise to about 15 centipoise, from about 1 centipoise to about 12 centipoise, from about 1 centipoise to about 10 centipoise, from about 1 centipoise to about 8 centipoise, from about 1 centipoise to about 5 centipoise, from about 3 centipoise to 19.5 centipoise, from about 3 centipoise to about 15 centipoise, from about 3 centipoise to about 10 centipoise, from about 3 centipoise to about 7 centipoise, from about 5 centipoise to 19.5 centipoise, from about 5 centipoise to about 15 centipoise, from about 5 centipoise to about 12 centipoise, from about 5 centipoise to about 8 centipoise, from about 7 centipoise to 19.5 centipoise, from about 7 centipoise to about 15 centipoise, from about 7 centipoise to about 12 centipoise, from about 7 centipoise to about 10 centipoise, etc.

The migrating starch can be added to the stucco slurry in dry form in some embodiments, but can be added wet (e.g., in solution) if desired in alternate embodiments. The migrating starch can be present in any suitable amount in the stucco slurry, e.g., to be effective in reducing incidence of surface calcination and/or to improve cover sheet-gypsum layer bond. For example, in some embodiments, the migrating starch is in an amount of from about 1 to about 8 pounds of migrating starch per thousand square feet of board formed from the slurry, e.g., from about 1 to about 5 pounds per thousand square feet of board, from about 1 to about 3 pounds per thousand square feet of board, from about 3 to about 8 pounds per thousand square feet of board, from about 3 to about 5 pounds per thousand square feet of board, from about 5 to about 8 pounds per thousand square feet of board, etc. In some embodiments, the migrating starch is present in an amount of from about 0.1% to about 1% by weight of stucco, e.g., from about 0.2% to about 0.5% by weight of stucco, or from about 0.3% to about 0.4% by weight of stucco.

The amount of migration of the starch according to the disclosure can be determined by measuring organic content near the interface of the gypsum layer and the cover sheet. For example, a cross-section of the gypsum layer can be divided into three segments of equal thickness along horizontal planes parallel to the cover sheet. Preferably, the total organic content is highest in the segment adjacent to the cover sheet. In some such embodiments, the lowest organic content is in the segment furthest away from the cover sheet. The organic content can be determined by use of a known thermal gravimetric analyzer, TGA/DSC 3+(Mettler-Toledo, Columbus, Ohio). The procedure involves heating a sample from 25° C. to 200° C. in the presence of nitrogen, then from 200° C. to 500° C. in the presence of oxygen. The material burned off between 200° C. and 500° C. represents total organic materials.

The stucco slurry is normally formed inside a pin or pinless main mixer during the manufacturing process. The slurry is formulated to include the migrating starch in accordance with the present disclosure, water, stucco, foaming agent (sometimes referred to simply as “foam”), and other additives as desired. Multiple gypsum layers formed from separate gypsum slurries can be used as in embodiments containing a concentrated layer as described in co-pending U.S. patent application Ser. Nos. 15/186,176; 15/186,212; 15/186,232; and 15/186,257, which concentrated layer arrangements are incorporated herein by reference. The stucco can be in the form of calcium sulfate alpha hemihydrate, calcium sulfate beta hemihydrate, and/or calcium sulfate anhydrite. The stucco can be fibrous or non-fibrous. Foaming agent can be included to form an air void distribution within the continuous crystalline matrix of set gypsum.

The mode of introduction of additives into the mixer may vary. For example, various combinations of components may be pre-mixed before entering the mixer, e.g., one or more dry additives and/or one or more wet additives may be pre-mixed. By “added to the slurry,” as used herein, it will be understood that ingredients may be pre-mixed in any suitable manner prior to entry into the mixer where the gypsum slurry (sometimes called “stucco slurry”) is formed as set forth herein. The additives can be included in the gypsum slurry in a wet or dry form. If in a wet form, the additives can be included in any suitable concentration, and could be pre-mixed with other wet additives.

In some embodiments, the foaming agent comprises a major weight portion of unstable component, and a minor weight portion of stable component (e.g., where unstable and blend of stable/unstable are combined). The weight ratio of unstable component to stable component is effective to form an air void distribution within the set gypsum core. See, e.g., U.S. Pat. Nos. 5,643,510; 6,342,284; and 6,632,550. It has been found that suitable void distribution and wall thickness (independently) can be effective to enhance strength, especially in lower density board (e.g., below about 35 pcf). See, e.g., US 2007/0048490 and US 2008/0090068. Evaporative water voids, generally having voids of about 5 μm or less in diameter, also contribute to the total void distribution along with the aforementioned air (foam) voids. In some embodiments, the volume ratio of voids with a pore size greater than about 5 microns to the voids with a pore size of about 5 microns or less, is from about 0.5:1 to about 9:1, such as, for example, about 0.7:1 to about 9:1, about 0.8:1 to about 9:1, about 1.4:1 to about 9:1, about 1.8:1 to about 9:1, about 2.3:1 to about 9:1, about 0.7:1 to about 6:1, about 1.4:1 to about 6:1, about 1.8:1 to about 6:1, about 0.7:1 to about 4:1, about 1.4:1 to about 4:1, about 1.8:1 to about 4:1, about 0.5:1 to about 2.3:1, about 0.7:1 to about 2.3:1, about 0.8:1 to about 2.3:1, about 1.4:1 to about 2.3:1, about 1.8:1 to about 2.3:1, etc. In some embodiments, the foaming agent is present in the slurry, e.g., in an amount of less than about 0.5% by weight of the stucco such as about 0.01% to about 0.5%, about 0.01% to about 0.4%, about 0.01% to about 0.3%, about 0.01% to about 0.2%, about 0.01% to about 0.1%, about 0.02% to about 0.4%, about 0.02% to about 0.3%, about 0.02% to about 0.2%, etc.

Additives such as accelerator (e.g., wet gypsum accelerator, heat resistant accelerator, climate stabilized accelerator) and retarder are well known and can be included in the stucco slurry, if desired. See, e.g., U.S. Pat. Nos. 3,573,947 and 6,409,825. In some embodiments where accelerator and/or retarder are included, the accelerator and/or retarder each can be in the stucco slurry in an amount on a solid basis of, e.g., from about 0% to about 10% by weight of the stucco (e.g., about 0.1% to about 10%), such as, for example, from about 0% to about 5% by weight of the stucco (e.g., about 0.1% to about 5%). Other additives as desired may be included, e.g., to impart strength to enable lower weight product with sufficient strength, to avoid permanent deformation, to promote green strength, e.g., as the product is setting on the conveyor traveling down a manufacturing line, to promote fire resistance, to promote water resistance, etc.

The migrating starch of high cold-water solubility and low viscosity according to the present disclosure can be used in preparing board of any suitable weight or density. In some embodiments, the migrating starch has particular utility with lower density board, e.g., having a density of about 35 pcf or less which has less gypsum crystal density to penetrate the cover sheet. In some embodiments, to enhance board strength, the slurry further comprises a strength additive such as a pregelatinized starch with viscosity above about 20 centipoise according to the VMA method; an uncooked starch as described in U.S. patent application Ser. Nos. 62/550,373, 15/971,766, 15/934,088, and 16/027,028; an alkylated starch, etc., as described in, e.g., U.S. Pat. No. 9,540,810, and U.S. patent applications Ser. Nos. 13/835,002 and 14/494,547. The strength additive can be included, for example, in an amount from about 0.1% to about 20% by weight of the stucco, such as from about 0.5% to about 10% by weight of the stucco.

The slurry can optionally include at least one dispersant to enhance fluidity in some embodiments. Like other ingredients, the dispersants may be included in a dry form with other dry ingredients and/or in a liquid form with other liquid ingredients in the core slurry. Examples of dispersants include naphthalenesulfonates, such as polynaphthalenesulfonic acid and its salts (polynaphthalenesulfonates) and derivatives, which are condensation products of naphthalenesulfonic acids and formaldehyde; as well as polycarboxylate dispersants, such as polycarboxylic ethers, for example, PCE211, PCE111, 1641, 1641F, or PCE 2641-Type Dispersants, e.g., MELFLUX 2641F, MELFLUX 2651F, MELFLUX 1641F, MELFLUX 2500L dispersants (BASF), and COATEX Ethacryl M, available from Coatex, Inc.; and/or lignosulfonates or sulfonated lignin. Lignosulfonates are water-soluble anionic polyelectrolyte polymers, byproducts from the production of wood pulp using sulfite pulping. One example of a lignin useful in the practice of principles of embodiments of the present invention is Marasperse C-21 available from Reed Lignin Inc.

Lower molecular weight dispersants are generally preferred. Lower molecular weight naphthalenesulfonate dispersants are favored because they trend to a lower water demand than the higher viscosity, higher molecular weight dispersants. Thus, molecular weights from about 3,000 to about 10,000 (e.g., about 8,000 to about 10,000) are preferred. As another illustration, for PCE211 type dispersants, in some embodiments, the molecular weight can be from about 20,000 to about 60,000, which exhibit less retardation than dispersants having molecular weight above 60,000.

One example of a naphthalenesulfonate is DILOFLO, available from GEO Specialty Chemicals. DILOFLO is a 45% naphthalenesulfonate solution in water, although other aqueous solutions, for example, in the range of about 35% to about 55% by weight solids content, are also readily available. Naphthalenesulfonates can be used in dry solid or powder form, such as LOMAR D, available from GEO Specialty Chemicals, for example. Another exemplary naphthalenesulfonate is DAXAD, available from Hampshire Chemical Corp.

If included, the dispersant can be included in any suitable (solids/solids) amount, such as, for example, about 0.1% to about 5% by weight of the stucco, e.g., about 0.1% to about 4%, about 0.1% to about 3%, about 0.2% to about 3%, about 0.5% to about 3%, about 0.5% to about 2.5%, about 0.5% to about 2%, about 0.5% to about 1.5%, etc.

One or more phosphate-containing compounds can also be optionally included in the slurry, if desired. For example, phosphate-containing components useful in some embodiments include water-soluble components and can be in the form of an ion, a salt, or an acid, namely, condensed phosphoric acids, each of which comprises two or more phosphoric acid units; salts or ions of condensed phosphates, each of which comprises two or more phosphate units; and monobasic salts or monovalent ions of orthophosphates as well as water-soluble acyclic polyphosphate salt. See, e.g., U.S. Pat. Nos. 6,342,284; 6,632,550; 6,815,049; and 6,822,033.

Phosphate-containing components in accordance with some embodiments of the invention can enhance green strength, resistance to permanent deformation (e.g., sag), dimensional stability, etc. Trimetaphosphate compounds can be used, including, for example, sodium trimetaphosphate, potassium trimetaphosphate, lithium trimetaphosphate, and ammonium trimetaphosphate. Sodium trimetaphosphate (STMP) is preferred, although other phosphates may be suitable, including for example sodium tetrametaphosphate, sodium hexametaphosphate having from about 6 to about 27 repeating phosphate units and having the molecular formula Naₙ₊₂PₙO₃ₙ₊₁ wherein n=6-27, tetrapotassium pyrophosphate having the molecular formula K₄P₂O₇, trisodium dipotassium tripolyphosphate having the molecular formula Na₃K₂P₃O₁₀, sodium tripolyphosphate having the molecular formula Na₅P₃O₁₀, tetrasodium pyrophosphate having the molecular formula Na₄P₂O₇, aluminum trimetaphosphate having the molecular formula Al(PO₃)₃, sodium acid pyrophosphate having the molecular formula Na₂H₂P₂O₇, ammonium polyphosphate having 1000-3000 repeating phosphate units and having the molecular formula (NH₄)ₙ₊₂PₙO₃ₙ₊₁ wherein n=1000-3000, or polyphosphoric acid having two or more repeating phosphoric acid units and having the molecular formula Hₙ₊₂PₙO₃ₙ₊₁ wherein n is two or more.

The phosphate can be included in a dry form or in a form in water (e.g., a phosphate solution from about 5% to about 20%, such as about a 10% solution). If included, the phosphate can be in any suitable amount (solids/solids basis), such as from about 0.01% to about 0.5% by weight of the stucco, e.g., from about 0.03% to about 0.4%, from about 0.1% to about 0.3%, or from about 0.12% to about 0.4% by weight of the stucco.

The slurry formulation can be made with any suitable water/stucco ratio, e.g., about 0.4 to about 1.3. For example, in some embodiments, the water/stucco ratio can be from about 0.4 to about 1.2, about 0.4 to about 1.1, about 0.4 to about 1, about 0.4 to about 0.9, about 0.4 to about 0.85, about 0.45 to about 0.85, about 0.5 to about 1.3, about 0.5 to about 1, about 0.5 to about 0.9, about 0.55 to about 0.85, about 0.55 to about 0.8, about 0.6 to about 1.3, about 0.6 to about 1.2, about 0.6 to about 1, about 0.6 to about 0.9, about 0.6 to about 0.85, about 0.6 to about 0.8, etc.

The cover sheets can be formed of any suitable material and basis weight. Advantageously, board core formed from slurry comprising migrating starch and strength additive (e.g., uncooked starch, pregelatinized starch, ethylated starch, etc.) provides sufficient strength in board even with lower basis weight cover sheets such as, for example, less than 45 lbs/MSF (e.g., about 33 lbs/MSF to 45 lbs/MSF) even for lower weight board (e.g., having a density of about 35 pcf or below) in some embodiments. However, if desired, in some embodiments, heavier basis weights can be used, e.g., to further enhance nail pull resistance or to enhance handling, e.g., to facilitate desirable “feel” characteristics for end-users.

In some embodiments, to enhance strength (e.g., nail pull strength), especially for lower density board, one or both of the cover sheets can be formed from paper and have a basis weight of, for example, at least about 45 lbs/MSF (e.g., from about 45 lbs/MSF to about 65 lbs/MSF, about 45 lbs/MSF to about 60 lbs/MSF, about 45 lbs/MSF to about 55 lbs/MSF, about 50 lbs/MSF to about 65 lbs/MSF, about 50 lbs/MSF to about 60 lbs/MSF, etc.). If desired, in some embodiments, one cover sheet (e.g., the “face” paper side when installed) can have aforementioned higher basis weight, e.g., to enhance nail pull resistance and handling, while the other cover sheet (e.g., the “back” sheet when the board is installed) can have somewhat lower weight basis if desired (e.g., weight basis of less than 45 lbs/MSF, e.g., from about 33 lbs/MSF to 45 lbs/MSF (e.g., about 33 lbs/MSF to about 40 lbs/MSF).

Board weight is a function of thickness. Since boards are commonly made at varying thickness, board density is used herein as a measure of board weight. The advantages of the migrating starch in accordance with embodiments of the disclosure can be seen across various board densities, e.g., about 42 pcf or less, such as from about 10 pcf to about 42 pcf, from about 12 pcf to about 40 pcf, from about 16 pcf to about 35 pcf, from about 20 pcf to about 40 pcf, from about 24 pcf to about 37 pcf, etc. However, preferred embodiments of the invention have particular utility at lower densities, e.g. from about 12 pcf to about 35 pcf, from about 12 pcf to about 30 pcf, from about 12 pcf to about 27 pcf, from about 16 pcf to about 30 pcf, from about 16 pcf to about 27 pcf, from about 16 pcf to about 24 pcf, from about 18 pcf to about 30 pcf, from about 18 pcf to about 27 pcf, from about 20 pcf to about 30 pcf, from about 20 pcf to about 27 pcf, from about 24 pcf to about 35 pcf, from about 27 pcf to about 35 pcf, from about 27 pcf to about 34 pcf, from about 30 pcf to about 34 pcf, about 27 pcf to about 30 pcf, etc.

In some embodiments, board according to the invention meets test protocols according to ASTM Standard C473-10, method B. For example, in some embodiments, when the board is cast at a thickness of ½ inch, the board has a nail pull resistance of at least about 65 lb as determined according to ASTM C 473-10, method B (e.g., at least about 68 lb, at least about 70 lb, at least about 72 lb, at least about 75 lb, at least about 77 lb, in each case with any suitable upper limit, such as 110 lb or higher, etc.). With respect to flexural strength, in some embodiments, when cast in a board of ½ inch thickness, the board has a flexural strength of at least about 36 lb in a machine direction (e.g., at least about 38 lb, at least about 40 lb, etc., in each case with any suitable upper limit, such as 80 lb or higher, etc.) and/or at least about 107 lb (e.g., at least about 110 lb, at least about 112 lb, etc., in each case with any suitable upper limit, such as 140 lb or higher, etc.) in a cross-machine direction as determined according to the ASTM standard C473. In some embodiments, these standards can be met even with respect to lower density board (e.g., about 35 pcf or less) as described herein.

In preferred embodiments, the board made from a slurry using cold-water soluble migrating starch as described herein results in good strength performance, including with respect to the cover sheet-gypsum layer bond. For example, in some embodiments, the board has a flexural strength in the cross machine direction face up (flex CFU) of at least about 150 lbs (e.g., from about 150 lbs to about 400 lbs), as measured according to ASTM C 473-07. In some embodiments, the board has a flexural strength in the cross machine direction face down (flex CFD) of at least about 150 lbs (e.g., from about 150 lbs to about 400 lbs), as measured according to ASTM C 473-07. In some embodiments, the board has a flexural strength in the machine direction face up (flex PFU) of at least about 50 lbs (e.g., from about 50 lbs to about 300 lbs), as measured according to ASTM C 473-07. In some embodiments, the board has a flexural strength in the machine direction face down (flex PFD) of at least about 50 lbs (e.g., from about 50 lbs to about 300 lbs), as measured according to ASTM C 473-07. The cross-direction refers to the direction perpendicular to the direction the manufacturing line is moving, while the machine direction refers to the direction parallel to the direction the manufacturing line is moving. The board can be measured both face up and face down, e.g., in order to determine the different strength values due to possible differences between the paper used on the face and back of the board.

In some embodiments, the board has a Bond F Fail, which refers to separation of face paper and core, of less than about 50% (e.g., from about 0% to about 50%). In some embodiments, the board has a Bond F Load, which refers to the force to pull the face paper apart from board, of at least about 11 lbs. In some embodiments, the board has a Bond B Fail, which refers to separation of back paper and core, of at least about 11 lbs. In some embodiments, the board has a Bond B Load, which refers to the force to pull the back paper apart from board, of at least about 11 lbs. The aforementioned bond tests are measured using an ATS Universal Test instrument. A board sample specimen is cut five inches in the machine direction and six inches in the cross direction. A ⅛ inch deep straight score (cut), parallel with the long direction of the specimen, is made two inches from one edge. The interface opposite to the score is evaluated for bond load. The core of the specimen is carefully broken along the score without inducing bond failure. The specimen is clamped in a test fixture. The score is aligned exactly over the apex of the test fixture, with the specimen edges squared with the fixture. The fixture is bolted to a flat surface, so that a crosshead exerts a perpendicular force along a leading edge of the specimen. The crosshead is positioned and the test is started. After the specimen fails, the crosshead should return to its starting position.

End Hardness refers to the force required to push a steel punch into an end of the board resulting from a knife cutting off a continuous strip of the board along the length of the board (i.e., a length of eight feet), without paper on the surface of the end. In some embodiments, the board has an End Hardness of at least about 11 lbs. In some embodiments, the board has a board compressive strength (BCS) of at least about 300 psi, as measured by applying a load continuously and without a shock at speed of 0.04 inch/min (with a constant rate between 15 to 40 psi/s) using an MTS system (Model # SATEC). In various embodiments, board according to the present disclosure can demonstrate any combination of the aforementioned properties discussed herein.

Product according to embodiments of the disclosure can be made on typical manufacturing lines. For example, board manufacturing techniques are described in, for example, U.S. Pat. No. 7,364,676 and U.S. Patent Application Publication 2010/0247937. Briefly, in the case of gypsum board, the process typically involves discharging a cover sheet onto a moving conveyor. Since gypsum board is normally formed “face down,” this cover sheet is the “face” cover sheet in such embodiments.

Dry and/or wet components of the gypsum slurry are fed to a mixer (e.g., pin or pin-less mixer), where they are agitated to form the gypsum slurry. The mixer comprises a main body and a discharge conduit (e.g., a gate-canister-boot arrangement as known in the art, or an arrangement as described in U.S. Pat. Nos. 6,494,609 and 6,874,930). In some embodiments, the discharge conduit can include a slurry distributor with either a single feed inlet or multiple feed inlets, such as those described in U.S. Patent Application Publication 2012/0168527 A1 (application Ser. No. 13/341,016) and U.S. Patent Application Publication 2012/0170403 A1 (application Ser. No. 13/341,209), for example. In those embodiments, using a slurry distributor with multiple feed inlets, the discharge conduit can include a suitable flow splitter, such as those described in U.S. Patent Application Publication 2012/0170403 A1. Foaming agent can be added in the discharge conduit of the mixer (e.g., in the gate as described, for example, in U.S. Pat. Nos. 5,683,635 and 6,494,609) or in the main body if desired. Slurry discharged from the discharge conduit after all ingredients have been added, including foaming agent, is the primary gypsum slurry and will form the board core. This board core slurry is discharged onto the moving face cover sheet.

The face cover sheet may optionally be in bonding relation with a thin skim coat in the form of a relatively dense layer of slurry. Also, hard edges, as known in the art, can be formed, e.g., from the same slurry stream forming the face skim coat. In embodiments where foam is inserted into the discharge conduit, a stream of secondary gypsum slurry can be removed from the mixer body to form the dense skim coat slurry, which can then be used to form the face skim coat and hard edges as known in the art. If included, normally the face skim coat and hard edges are deposited onto the moving face cover sheet before the core slurry is deposited, usually upstream of the mixer. After being discharged from the discharge conduit, the core slurry is spread, as necessary, over the face cover sheet (optionally bearing skim coat) and covered with a second cover sheet (typically the “back” cover sheet) to form a wet assembly in the form of a sandwich structure that is a precursor to the final product. The second cover sheet may optionally bear a second skim coat, which can be formed from the same or different secondary (dense) gypsum slurry as for the face skim coat, if present. The cover sheets may be formed from paper, fibrous mat or other type of material (e.g., foil, plastic, glass mat, non-woven material such as blend of cellulosic and inorganic filler, etc.).

The wet assembly thereby provided is conveyed to a forming station where the product is sized to a desired thickness (e.g., via forming plate), and to one or more knife sections where it is cut to a desired length. The wet assembly is allowed to harden to form the interlocking crystalline matrix of set gypsum, and excess water is removed using a drying process (e.g., by transporting the assembly through a kiln). It also is common in the manufacture of gypsum board to use vibration in order to eliminate large voids or air pockets from the deposited slurry. Each of the above steps, as well as processes and equipment for performing such steps, are known in the art.

The invention is further illustrated by the following exemplary embodiments. However, the invention is not limited by the following embodiments.

(1) A gypsum board, slurry, or method of preparing gypsum board as described herein.

(2) A gypsum board comprising a set gypsum core disposed between two cover sheets, the core formed from a slurry comprising stucco, water, and at least one migrating starch having a cold-water solubility of at least about 25% and a viscosity of less than about 20 centipoise, as determined according to the VMA method.

(3) The gypsum board of embodiment 2, wherein the migrating starch is acid-modified.

(4) The gypsum board of embodiments 2 or 3, the migrating starch having a cold-water solubility greater than about 30%.

(5) The gypsum board of embodiment 4, the migrating starch having a cold-water solubility greater than about 40%.

(6) The gypsum board of embodiments 2 or 3, the migrating starch having a cold-water solubility of from about 25% to about 70%.

(7) The gypsum board of embodiments 2 or 3, the migrating starch having a cold-water solubility of from about 25% to about 60%.

(8) The gypsum board of embodiments 2 or 3, the migrating starch having a cold-water solubility of from about 25% to about 50%.

(9) The gypsum board of any one of embodiments 1-8, the migrating starch having a viscosity of from about 1 centipoise to 19.5 centipoise.

(10) The gypsum board of any one of embodiments 1-8, the migrating starch having a viscosity of from about 1 centipoise to 19 centipoise.

(11) The gypsum board of any one of embodiments 1-8, the migrating starch having a viscosity of from about 1 centipoise to about 15 centipoise.

(12) The gypsum board of any one of embodiments 1-11, the migrating starch being present in an amount of from about 1 to about 8 pounds of migrating starch per thousand square feet of board formed from the slurry.

(13) The gypsum board of any one of embodiments 1-12, the slurry further comprising a pregelatinized starch.

(14) The gypsum board of any one of embodiments 1-13, the slurry further comprising an alkylated starch.

(15) The gypsum board of any one of embodiments 1-14, the slurry further comprising a dispersant.

(16) The gypsum board of any one of embodiments 1-15, the slurry further comprising a polyphosphate.

(17) The gypsum board of embodiment 16, wherein the polyphosphate is sodium trimetaphosphate.

(18) A slurry comprising stucco, water, and at least one migrating starch having a cold-water solubility of at least about 25% and a viscosity of less than about 20 centipoise, as determined according to the VMA method.

(19) The slurry of embodiment 18, wherein the migrating starch is acid-modified.

(20) The slurry of embodiments 18 or 19, the migrating starch having a cold-water solubility greater than about 30%.

(21) The slurry of embodiment 20, the migrating starch having a cold-water solubility greater than about 40%.

(22) The slurry of embodiments 18 or 19, the migrating starch having a cold-water solubility of from about 25% to about 70%.

(23) The slurry of embodiments 18 or 19, the migrating starch having a cold-water solubility of from about 25% to about 60%.

(24) The slurry of embodiments 18 or 19, the migrating starch having a cold-water solubility of from about 25% to about 50%.

(25) The slurry of any one of embodiments 18-24, the migrating starch having a viscosity of from about 1 centipoise to 19.5 centipoise.

(26) The slurry of any one of embodiments 18-24, the migrating starch having a viscosity of from about 1 centipoise to 19 centipoise.

(27) The slurry of any one of embodiments 18-24, the migrating starch having a viscosity of from about 1 centipoise to about 15 centipoise.

(28) The slurry of any one of embodiments 18-27, the migrating starch being present in an amount of from about 1 to about 8 pounds of migrating starch per thousand square feet of board formed from the slurry.

(29) The slurry of any one of embodiments 18-28, the slurry further comprising a pregelatinized starch.

(30) The slurry of any one of embodiments 18-29, the slurry further comprising an alkylated starch.

(31) The slurry of any one of embodiments 18-30, the slurry further comprising a dispersant.

(32) The slurry of any one of embodiments 18-31, the slurry further comprising a polyphosphate.

(33) The slurry of embodiment 32, wherein the polyphosphate is sodium trimetaphosphate.

(34) A method of making gypsum board comprising: (a) mixing at least water, stucco, and at least one migrating starch to form a slurry, (b) disposing the slurry between a first cover sheet and a second cover sheet to form a wet assembly, (c) cutting the wet assembly into a board, and (d) drying the board; the migrating starch having a cold-water solubility of at least about 25% and a viscosity of less than about 20 centipoise, as determined according to the VMA method.

(35) The method of embodiment 34, wherein the migrating starch is acid-modified.

(36) The method of embodiments 34 or 35, the migrating starch having a cold-water solubility greater than about 30%.

(37) The method of embodiment 36, the migrating starch having a cold-water solubility greater than about 40%.

(38) The method of embodiments 34 or 35, the migrating starch having a cold-water solubility of from about 25% to about 70%.

(39) The method of embodiments 34 or 35, the migrating starch having a cold-water solubility of from about 25% to about 60%.

(40) The method of embodiments 34 or 35, the migrating starch having a cold-water solubility of from about 25% to about 50%.

(41) The method of any one of embodiments 34-40, the migrating starch having a viscosity of from about 1 centipoise to 19.5 centipoise.

(42) The method of any one of embodiments 34-40, the migrating starch having a viscosity of from about 1 centipoise to 19 centipoise.

(43) The method of any one of embodiments 34-40, the migrating starch having a viscosity of from about 1 centipoise to about 15 centipoise.

(44) The method of any one of embodiments 34-43, the migrating starch being present in an amount of from about 1 to about 8 pounds of migrating starch per thousand square feet of board formed from the slurry.

(45) The method of any one of embodiments 34-44, the slurry further comprising a pregelatinized starch.

(46) The method of any one of embodiments 34-45, the slurry further comprising an alkylated starch.

(47) The method of any one of embodiments 34-46, the slurry further comprising a dispersant.

(48) The method of any one of embodiments 34-47, the slurry further comprising a polyphosphate.

(49) The method of embodiment 48, wherein the polyphosphate is sodium trimetaphosphate.

It shall be noted that the preceding are merely examples of embodiments. Other exemplary embodiments are apparent from the entirety of the description herein. It will also be understood by one of ordinary skill in the art that each of these embodiments may be used in various combinations with the other embodiments provided herein.

The following example(s) further illustrate the invention but, of course, should not be construed as in any way limiting its scope.

### EXAMPLE 1

This example demonstrates benefits of using a cold-water soluble migrating starch in a stucco slurry. Gypsum board formed from a slurry containing cold-water soluble migrating starch provided improved strength, including with respect to the bond between a cover sheet and a gypsum layer in the gypsum board.

In particular, two boards were prepared on a gypsum wallboard manufacturing line operating at a production line speed of 210 feet per minute (fpm). One board was formed from slurry that included a cold-water soluble migrating starch and no dextrose, which was compared with another board formed from a slurry comprising dextrose but no cold-water soluble starch. Dextrose was selected for comparative testing because it is believed to have the ability to provide protection from surface calcination, although it is less desirable because of manufacturing cost considerations. The respective slurry formulations for preparing comparative board A (slurry composition A) and board B (slurry composition B) are set forth in Table 1.

The slurries contained stucco, water, either dextrose or cold-water soluble migrating starch, and optional additives as desired. The boards A and B were prepared to have fire rating performance (Type X) and thus included vermiculite and glass fiber which are optional, along with other ingredients, as noted above, since fire rating performance is not required in the practice of embodiments of the present disclosure. Compositions A and B were prepared from dry and wet mixes that were combined on the gypsum wallboard manufacturing line. Each wet mix was prepared by weighing the water, dispersant, retarder, dispersant, and sodium trimetaphosphate 10% solution in a mixer at the wet end of the gypsum wallboard manufacturing line. The sodium trimetaphosphate 10% solution was prepared by dissolving 10 parts (weight) of sodium trimetaphosphate in 90 parts (weight) of water, while the retarder solution was composed of an aqueous solution of the pentasodium salt of diethylenetriaminepentaacetic acid (Versenex™ 80, commercially available from DOW Chemical Company, Midland, Mich.). The remaining ingredients, particularly, the stucco, heat resistant accelerator, and starch (if present), were weighed and metered into the mixer with a screw feeder. The heat resistant accelerator was composed of ground up land plaster and dextrose.

Foam was added in order to reduce board density (and hence weight). For foam preparation, a 0.5% solution of Hyonic™ PFM-33 soap (available from GEO Specialty Chemicals, Ambler, Pa.) was formed and then mixed with air to make the air foam. The air foam was added to the slurry using a foam ring.

A starch with high cold-water solubility (HS-LC211) was prepared from highly acid-modified sorghum and/or corn starch by increasing the degree of acid hydrolysis. This starch was used to replace dextrose in preparing a ⅝ inch thick board useful for attaining a Fire Code X rating. The water to stucco ratio was 0.79. The ratio of unstable to stable soap was 85:15.

TABLE 1
Formulation of Slurry Compositions

| | | Composi- | | |
|---|---|---|---|---|
| | | tion A | | Composi- |
| | Composi- | (Weight | | tion B |
| | tion A | Percent, | Composi- | (Weight |
| | Weight | stucco | tion B | Percent, |
| | (lbs/msf) | basis) | Weight | stucco |
| | (comparative) | (comparative) | (lbs/msf) | basis) |
| Stucco | 1475 | 100 | 1475 | 100 |
| Heat Resistant | 8.2 | 0.56 | 8.2 | 0.56 |
| Accelerator | | | | |
| Pregelatinized | 8.6 | 0.58 | 8.6 | 0.58 |
| starch | | | | |
| Dextrose | 2 | 0.14 | 0 | 0 |
| Migrating | 0 | 0 | 2 | 0.14 |
| starch | | | | |
| (HS-LC211) | | | | |
| Sodium | 1.9 | 0.13 | 1.9 | 0.13 |
| trimetaphos- | | | | |
| phate | | | | |
| Dispersant | 4 | 0.27 | 4 | 0.27 |
| Retarder | 0.22 | 0.015 | 0.22 | 0.015 |
| Vermiculite | 55 | 3.73 | 55 | 3.73 |
| Glass fiber | 9 | 0.61 | 9 | 0.61 |
| Total soap | 0.6 | 0.041 | 0.6 | 0.041 |
| Total water | 1170 | 79 | 1170 | 79 |

The properties of board made with migrating starch having cold-water solubility were compared with that of board made with dextrose. The results are shown in Table 2. Flex CFU refers to the flexural strength of the board in the cross machine direction, face up. Flex CFD refers to the flexural strength of the board in the cross machine direction, face down. Flex PFU refers to the flexural strength of the board in the machine direction, face up. Flex PFD refers to the flexural strength of the board in the machine direction face down. Bond F Fail refers to separation of face paper and core. Bond F Load refers to the force to pull the face paper apart from the board. Bond B Fail refers to the separation of the back paper and the core. Bond B Load refers to the force to pull the back paper apart from the board. ASTM End Hardness refers to the force required to push a steel punch into the end. BCS refers to board compressive strength.

TABLE 2
Board Properties

| | Board A | |
|---|---|---|
| | (comparative) | Board B |
| Dry Weight (lbs/msf) | 1872 | 1870.8 |
| Nail Pull (lbs) | 87 | 89 |
| Flex CFU (lbs) | 269 | 259 |
| Flex CFD (lbs) | 255 | 254 |
| Flex PFU (lbs) | 123 | 127 |
| Flex PFD (lbs) | 118 | 171 |
| Bond F Fail (%) | 0.0 | 0.0 |
| Bond F Load (lbs) | 24.3 | 21.5 |
| Bond B Fail (%) | 10.8 | 24.2 |
| Bond B Load (lbs) | 19.5 | 18.4 |
| ASTM End Hardness (lbs) | 17.9 | 16.6 |
| BCS (psi) | 397 | 400 |

As seen in Table 2, the board strength properties, including paper-core bond performance, were effective with the use of cold-water soluble migrating starch and comparable to the board prepared with dextrose. The bond failure of both face side and back side was below 50% and the bond load of both sides was above 11 lbs. The boards made with cold water soluble migrating starch showed good paper to core bond. The end hardness was 16.6 lbs, indicating no significant end calcination. Overall, boards prepared with cold-water soluble migrating starch passed all quality requirements and showed similar performance as boards formed from dextrose.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The term “bonding relation” does not require that two layers be in direct contact. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A gypsum board comprising a set gypsum core disposed between two cover sheets, the core formed from a slurry comprising stucco, water, and at least one migrating starch having a cold-water solubility of at least about 25% and a viscosity of less than about 20 centipoise, as determined according to the VMA method.

2. The gypsum board of claim 1, wherein the migrating starch is acid-modified, and has a cold-water solubility of at least about 35%.

3. The gypsum board of claim 1, the migrating starch having a viscosity of from about 1 centipoise to 19.5 centipoise.

4. The gypsum board of claim 1, the migrating starch being present in an amount of from about 1 to about 8 pounds of migrating starch per thousand square feet of board formed from the slurry.

5. The gypsum board of claim 1, the slurry further comprising a board strength additive comprising pregelatinized starch, uncooked starch, and/or alkylated starch.

6. The gypsum board of claim 1, the slurry further comprising a polyphosphate.

7. The gypsum board of claim 1, the slurry further comprising a dispersant and sodium trimetaphosphate.

8. A slurry comprising stucco, water, and at least one migrating starch having a cold-water solubility of at least about 25% and a viscosity of less than about 20 centipoise, as determined according to the VMA method.

9. The slurry of claim 8, wherein the migrating starch is acid-modified, and has a cold-water solubility of from about 35% to about 70%.

10. The slurry of claim 8, the migrating starch having a viscosity of from about 1 centipoise to 19 centipoise.

11. The slurry of claim 8, the slurry further comprising a strength additive comprising pregelatinized starch, uncooked starch, and/or alkylated starch.

12. The slurry of claim 11, the slurry further comprising a dispersant.

13. The slurry of claim 8, the slurry further comprising sodium trimetaphosphate.

14. A method of making gypsum board comprising:
(a) mixing at least water, stucco, and at least one migrating starch to form a slurry,
(b) disposing the slurry between a first cover sheet and a second cover sheet to form a wet assembly,
(c) cutting the wet assembly into a board, and
(d) drying the board;
the migrating starch having a cold-water solubility of at least about 25% and a viscosity of less than about 20 centipoise, as determined according to the VMA method.

15. The method of claim 14, wherein the migrating starch is acid-modified.

16. The method of claim 14, the migrating starch having a cold-water solubility of at least about 35%.

17. The method of claim 14, the migrating starch having a viscosity of from about 1 centipoise to 19 centipoise.

18. The method of claim 17, the migrating starch having a viscosity of from about 1 centipoise to about 15 centipoise.

19. The method of claim 18, the slurry further comprising a board strength additive comprising pregelatinized starch, uncooked starch, and/or alkylated starch.

20. The method of claim 18, the slurry further comprising a dispersant and sodium trimetaphosphate.
